(19) United States
(12) Patent Application Publication
(10) Pub. No.: US 2018/0307735 A1
(43) Pub. Date: Oct. 25, 2018

(54) INTEGRATING RELATIONAL AND NON-RELATIONAL DATABASES

(71) Applicant: CA, Inc., Islandia, NY (US)

(72) Inventors: Nicholas D. Thayer, Islandia, NY (US); James Perkins, Islandia, NY (US); Rajat Kumar Mishra, Hyderabad (IN); Kiran Prakash Diwakar, Pune (IN)

(21) Appl. No.: 15/491,300

(22) Filed: Apr. 19, 2017

(51) Int. Cl. G06F 17/30

(52) U.S. Cl. CPC G06F 17/30557; G06F 17/30292; G06F 17/30595; G06F 17/30554

(57) ABSTRACT

Provided is a process including: receiving a request for a user interface depicting data specified, at least in part, by the request; accessing data in a first type of database, the data in the first type of database including references to entries in a second type of database different from the first type of database, wherein the two types of databases include a relational database and a non-relational database; forming instructions to present a user interface depicting accessed data in the first type of database with inputs to effectuate access to data in the second type of database.

### BACKGROUND

### 1. Field

The present disclosure relates generally to computing and, more specifically, to integrating relational and non-relational databases.

### 2. Description of the Related Art

Various types of databases are often used in different scenarios. Often, these different types of databases present different trade-offs with respect to flexibility and consistency over time. For example, two types of databases presenting such trade-offs include relational databases and non-relational databases.

Often, relational databases arrange data in a collection of tables having columns corresponding to various fields and rows corresponding to values in each of the fields. Often, key values in one table appear in entries in another table, and the various tables may be joined or otherwise interrogated by referencing these key values. Often, data in these tables is arranged in third normal form to reduce duplicate entries and simplify maintenance of the database. Often, schemas of relational databases are generally fixed and difficult to change. Adding additional fields can often lead to a scenario in which the database needs to be re-factored to maintain third normal form. This can make it difficult to adapt to changing conditions or requirements. On the other hand, this consistency often makes it easier to program against these databases, as the developer often has some confidence that a query written for use with the database at one point in time will continue to operate in the future.

In contrast, another type of database is a non-relational database, such as a document oriented database or a key value store. In many cases, these non-relational databases do not have a fixed schema and are relatively accommodating of changes in the fields of information that are stored within the database. Thus, for example, as a data model evolves through continued development of an application, often non-relational databases are easier to adapt to the changing schema that results.

In many cases, applications that interface with databases are configured to interface with only one type of a database, for example, only with relational databases or only with non-relational databases. In some cases, it can be difficult to adapt such applications for use with other types of databases, often because the source code of the application is unavailable or because rewriting the source code is expensive, error-prone, and slow. Further, replicating data in different types of databases can be undesirable for various reasons, including problems arising from lack of consistency across different copies, and higher latency resulting from the need to access different databases to perform various database operations.

### SUMMARY

The following is a non-exhaustive listing of some aspects of the present techniques. These and other aspects are described in the following disclosure.

Some aspects include a process of forming user interfaces based on data that spans relational and non-relational databases, the process including: receiving, with one or more processors, a request for a user interface depicting data specified, at least in part, by the request; in response to receiving the request, accessing, with one or more processors, data in a first type of database, the data in the first type of database including references to entries in a second type of database different from the first type of database, wherein the two types of databases include a relational database and a non-relational database; forming, with one or more processors, instructions to present a user interface depicting accessed data in the first type of database specified, at least in part, by the request, wherein: the user interface includes a user-selectable visual element associated with an event handler and a first reference from the first type of database to one or more entries in the second type of database, the user-selectable visual element depicts at least some of the accessed data in the first type of database that is associated in the first type of database with the first reference to one or more entries in the second type of database, and user selection of the visual element causes the event handler to send an indication that the visual element was selected and the first reference from the first type of database to one or more entries in the second type of database; receiving, with one or more processors, the indication that the visual element was selected and the first reference from the first type of database to one or more entries in the second type of database; and in response to receiving the indication, accessing, with one or more processors, the one or more entries in the second type of database based on the first reference and causing the accessed one or more entries in the second type of database to be presented in the user interface.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a database translator consistent with some embodiments of the present techniques;

FIG. 2 shows an example of a process to translate database access requests consistent with some embodiments of the present techniques; and

FIG. 3 is an example of a computing device by which the above techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of database engineering and distributed computing software architecture. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

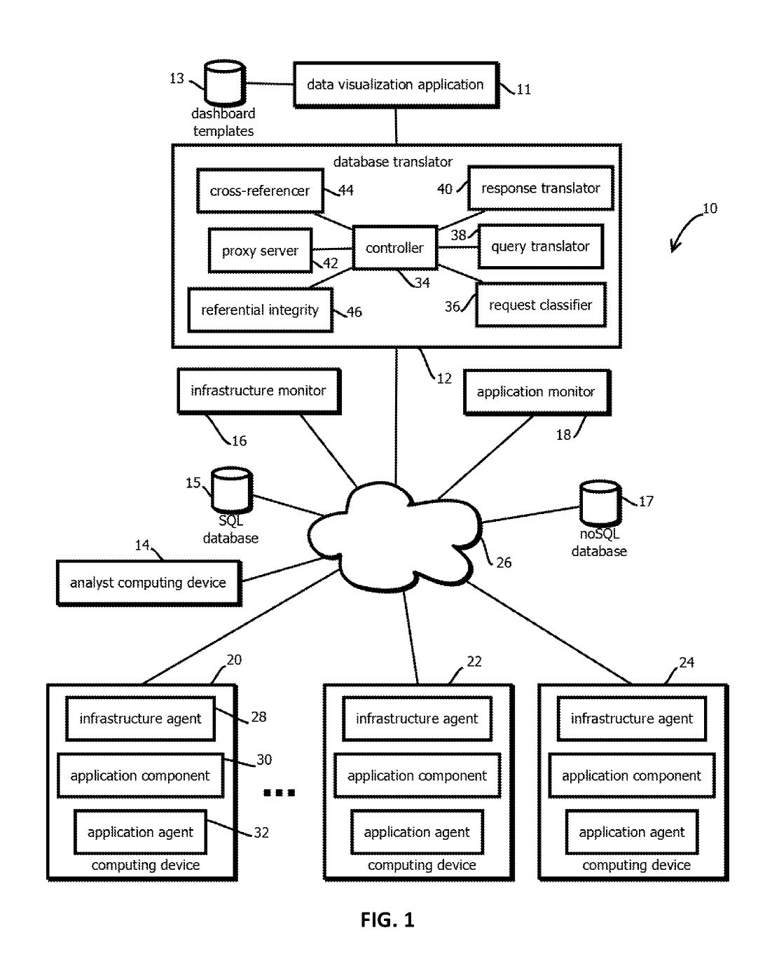

In some embodiments, some of the above-described issues may be mitigated by embodiments in a computing environment 10 shown in FIG. 1. In some embodiments, the computing environment 10 includes a database translator 12 configured to act as a translation layer between a data visualization application 11 and different types of databases 15 and 17. For example, databases 15 and 17 may be accessed in service of the data visualization application 11 preparing dashboard presentations for an analyst computing device 14, and the dashboards may present application monitoring data from an infrastructure monitoring application 16 and an application monitoring application 18.

In some embodiments, the database translator 12 may be configured to identify data in one of the databases that corresponds to data in the other database and insert foreign keys by which the data in the other database may be identified. In some cases, the foreign keys identify data in one database that is related to data in the other database by describing the same monitored computing transactions or the same monitored computing devices, for instance, on the same computing device at around the same time (e.g., within a threshold duration before or after). In some cases, these foreign keys may be inserted into data visualizations prepared by the data visualization application 11, such that user interaction with the resulting data visualization may cause the foreign keys related to the user interactions to be sent back to the database translator 12, which may retrieve the corresponding referenced data. As a result, in some embodiments, a user may view a dashboard depicting, for example, application performance monitoring data (e.g., from one type of database), select a visual element in the dashboard (for example, indicative of an anomaly in application performance), and that selection may cause infrastructure monitoring data (e.g., from a different type of database) that potentially indicates a cause of the alarm to be retrieved and presented in the user interface, thereby visually associating information from two different types of databases. In some cases, cross-database access may be implemented in a fashion that is transparent to the database translator 12 (or other accessing application), thereby facilitating use cases where source code of the accessing application is unavailable or difficult to modify to accommodate different types of databases. (That said, embodiments are not limited to systems that provide these benefits, as multiple, independently useful techniques are described and some embodiments afford other benefits, which is not to suggest that other described features are limiting.)

These techniques and others described below are better understood in view of the illustrated computing environment 10. In some embodiments, the computing environment 10 is a distributed computing environment including a relatively large number of computing devices, for instance, deployed over several datacenters or enterprise local area networks. In many cases, the number of computing devices with which the computing environment 10 is implemented is expected to exceed 10, and in many commercially relevant use cases, 100, or 1000. In this example, the computing environment 10 includes the database translator 12, an infrastructure monitor 16, an application monitor 18, a plurality of monitored computing devices 20, 22, and 24 executing a monitored distributed application, and a network 26, such as the Internet or various other intermediary networks, like local area networks.

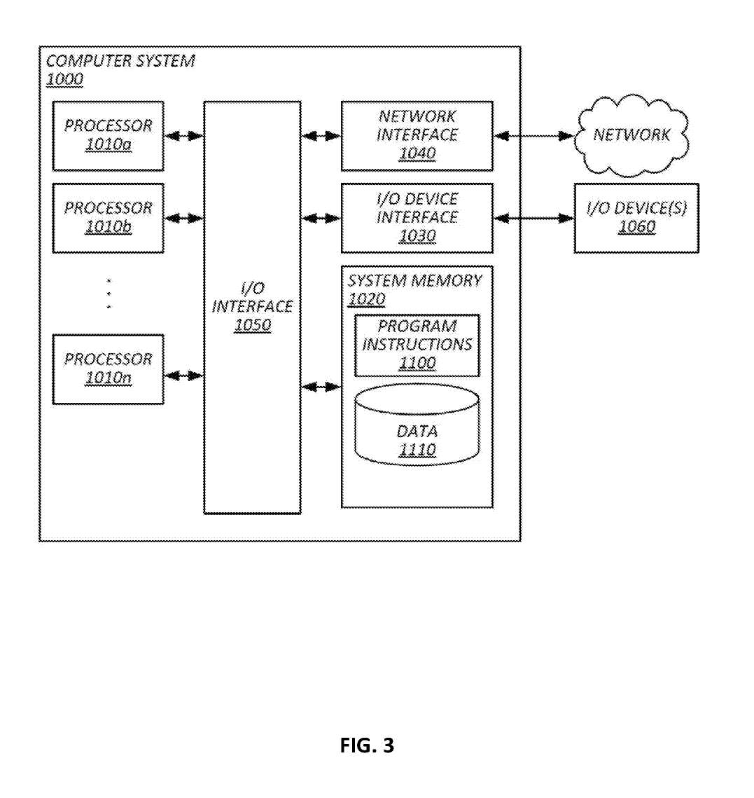

In some embodiments, the components of the system of FIG. 1 may be implemented with a plurality of the computing devices described below with reference to FIG. 3, for instance, with rack-mounted computing devices in a datacenter or a plurality of datacenters configured to communicate with one another via various networks, such as local area networks and the Internet. In some cases, the monitoring application may route communicate via a different network than that of the distributed application. For instance, the monitoring applications may communicate via an out-of-band network in a datacenter, while the distributed application may communicate via an in-band network. Out-of-band communications are expected to reduce an attack surface of the distributed application by maintaining at least some interfaces of the monitoring application on a network that is not exposed to the public Internet. Or in some cases, these communications may be consolidated on a single network, for instance to simplify the physical architecture.

Three computing devices 20, 22, and 24 are shown, but embodiments are expected to typically include many more, for instance, numbering in the dozens, hundreds, or thousands or more. In some embodiments, the computing devices 20, 22, and 24 may be rack-mounted computing devices in a datacenter, for instance, in a public or private cloud datacenter. In some embodiments, the computing devices 20, 22, and 24 may be geographically remote from one another, for instance, in different datacenters, and geographically remote from the other components 12, 14, 16, and 18, or these components may be collocated.

In some embodiments, the network 26 includes the public Internet and a plurality of different local area networks, for instance, each within a different respective datacenter connecting to a plurality of the computing devices 20 through 24. In some cases, the various components may connect to one another through the public Internet via an encrypted channel. In some cases, a datacenter may include an in-band network through which the data operated upon by the application is exchanged and an out-of-band network through which infrastructure monitoring data is exchanged. Or some embodiments may consolidate these networks.

In some embodiments, each of the computing devices 20 through 24 may execute a variety of different routines specified by installed software, which may include application software, monitoring software, and an operating system. Application software, in this context, serves a different purpose from monitoring software. The application software generally executes in service of a business function or other workload for which the computing environment 10 was provisioned by a user. In contrast, the monitoring software monitors and, in some cases, manages the operation of the application software or the computing devices upon which the application software is executed. In some embodiments, the computing environment 10 may execute a plurality of different distributed applications, in some cases intermingling components of these distributed applications on the same computing devices and, in some cases, with some of the distributed applications providing software tools by which other distributed applications are deployed, monitored, and adjusted. It is helpful to generally discuss these applications before addressing other components thereof within the computing environment 10. In some cases, such applications may be categorized as workload applications and infrastructure applications. The workload applications may service tasks for which the computing environment is designed and provided, e.g., hosting a web-based service, providing an enterprise resource management application, providing a customer-relationship management application, providing a document management application, providing an email service, or providing an industrial controls application, just to name a few examples. In contrast, infrastructure applications may exist to facilitate operation of the workload application. Examples include monitoring applications, logging applications, container management applications, and the like.

In some cases, the topology to be analyzed is that of the workload application software, which may be a distributed application, meaning that different components of the application software execute on different hosts, for instance, on different computing devices, in different virtual machines, in different containers, or in different operating systems having different memory address spaces. In some embodiments, each computing device may have a single host, or a given computing device may have multiple hosts, for instance, in the case of a computing device executing multiple virtual machines, each having a virtual machine operating system and executing within an operating system of the computing device. In some cases, each host may have a different network layer host address. A “host” need not be labeled as a host in program code or data structures to constitute a host, e.g., often hosts may be labeled as “servers” or “guests.”

In many cases, the application software is implemented with different application components 30 executing on the different hosts. In some cases, the different application components may communicate with one another via network messaging, for instance, via a local area network, the Internet, or a loopback network address on a given computing device. In some embodiments, the application components communicate with one another via respective application program interfaces, such as representational state transfer (REST) interfaces, for instance, in a microservices architecture. In some embodiments, each application component includes a plurality of routines, for instance, functions, methods, executables, or the like, in some cases configured to call one another. In some cases, the application components are configured to call other application components executing on other hosts, such as on other computing devices, for instance, with application program interface request including a command and parameters of the command. In some cases, some of the application components 30 may be identical to other application components on other hosts, for instance, those provided for load balancing purposes in order to concurrently service transactions. In some cases, some of the application components may be distinct from one another and serve different purposes, for instance, in different stages of a pipeline in which a transaction is processed by the distributed application. An example includes a web server that receives a request, a controller that composes a query to a database based on the request, a database that services the query and provides a query result, and a view generator that composes instructions for a web browser to render a display responsive to the request to the web server. Often, pipelines in commercial implementations are substantially more complex, for instance, including more than 10 or more than 20 stages, often with load-balancing at the various stages including more than 5 or more than 10 instances configured to service transactions at any given stage. Or some embodiments have a hub-and-spoke architecture, rather than a pipeline, or a combination thereof. In some cases, multiple software applications may be distributed across the same collection of computing devices, in some cases sharing some of the same instances of application components, and in some cases having distinct application components that are unshared.

With the complexity that can arise in distributed applications, it can be difficult to diagnose application performance issues or infrastructure issues. Accordingly, some embodiments include monitoring software. The monitoring software in this example is of different types that, while they perform monitoring, perform functions recognized as in industry as being in distinct product categories. Examples include infrastructure monitoring and application monitoring (e.g., application performance monitoring or application delivering monitoring). The former can be analogized to the diagnostic software used by an automotive mechanic to monitor a car's engine, while the latter can be analogized to GPS navigation software by which a car's direction and speed is tracked. Both relate to the operation of the car, but they are distinct categories of software. A similar relationship exists for application monitoring and infrastructure monitoring applications.

In some embodiments, the infrastructure monitoring software may be a distributed infrastructure management application that includes the infrastructure monitor 16 and infrastructure agents 28 installed on the computing devices 20 through 24. In some embodiments, the infrastructure agent may be installed on networking equipment as well, for instance, on switches and routers. Or some embodiments are partially or entirely agentless, and metrics, events, and attributes may be gathered with the various protocols described below for this purpose.

In some embodiments, the infrastructure agent is configured to gather attributes of the computing host upon which the infrastructure agent executes, such as a host name (or other type of host identifier), a network address, a medium access control address, a domain name service, a datacenter identifier, a datacenter region, a processor model, a processor speed, amounts of processor memory of various types of cache (e.g. L1 and L2), an operating system name, an operating system version, operating system configurations, firmware names, firmware versions, driver names, driver versions, installed application names, installed application versions, amounts of memory available in random access memory, memory speed, amounts of persistent storage available, persistent storage speed, and the like. In some embodiments, the infrastructure agent is configured to gather metrics of the host upon which the infrastructure agent executes, for instance, processor utilization, memory utilization, temperature, network bandwidth, network latency, rates of packet loss on networks, and the like. In some embodiments, the infrastructure agent is configured to gather events, such as alarms, indicative of occurrences at the host upon which the infrastructure agent executes, for instance, instances of the above metrics crossing (or changing faster than) a threshold, operating system errors, crashes, reboots, corrupted memory being detected, and the like.

In some embodiments, the infrastructure agent may be configured to report such gathered information to the infrastructure monitor 16, for instance, periodically, and buffer the information between reports. In some embodiments, the infrastructure agent may be configured to receive requests for such information from the infrastructure monitor 16 and respond with responsive information, for instance, all information buffered, or information responsive to a query from the infrastructure monitor 16.

In some embodiments, the infrastructure agent 28 may include a plurality of “probes,” which may be routines configured to gather information pertaining to a particular use case for the host, for example, probes configured to gather information about databases, email servers, web servers, and the like. In some embodiments, some infrastructure agents may have a plurality of probes and different infrastructure agents may have different pluralities of probes. Or in other architectures consistent with the present techniques, each “probe” may be characterized as an agent, e.g., a single host may have multiple specialized infrastructure or application performance monitoring agents.

In some use cases, system administrators do not have a way to easily take inventory of the computing devices upon which a given distributed application or plurality of distributed applications execute. Often computing devices or hosts executing thereon, are added and removed relatively frequently, often over diverse geographic areas, in some cases automatically responsive to changes in the applied load or crashes or maintenance elsewhere in the system. To ease this burden, some embodiments of the infrastructure monitor 16 are configured to automatically discover newly added hosts within a domain, for instance, new virtual machines that were added or new computing devices that were added. In some cases, the infrastructure monitor 16 may periodically, or in response to a command, scan a range of network addresses, like in a private subnet, with request sent according to various network management protocols, like Simple Network Management Protocol (SNMP), Secure Shell (SSH), Windows Management Instrumentation (WMI), or Internet Control Message Protocol (ICMP). If a computing device is not at a given address in the range, no response may be received within a threshold duration of time, and that address may be disregarded. In contrast, a new computing device or other host at a given address, upon receiving the network management protocol request may respond to the request, indicating the presence of a host. Upon detecting a new host, some embodiments of the infrastructure monitor 16 may direct the host to install an instance of the infrastructure agent and, in some cases, configure various probes thereon based upon a role indicated by the host.

In some embodiments, the infrastructure monitor 16 may receive information reported from the infrastructure agents and generate various dashboards, reports, and alarms based on this information. In some embodiments, the infrastructure monitor 16 is further configured to automatically take remedial action, for instance, provisioning additional computing devices responsive to thresholds being exceeded, like thresholds indicating CPU or memory usage greater than a threshold amount. In some embodiments, the infrastructure monitor 16 may organize the received information according to an identifier of a host upon which the infrastructure agent reporting the information is executing. Based upon discovered hosts, and in some cases information reported by those hosts, some embodiments of the infrastructure monitor 16 may construct a network-architecture topology of a physical architecture of computing devices within a domain. In some cases, this network-architecture topology may include network-architecture host identifiers for each of the hosts that were discovered or otherwise identified (for instance, manually identified and configured by a system administrator). In some cases, these host identifiers may be specified by a system administrator, or in some cases, the host itself.

In some embodiments, as discussed above, the monitoring software further includes application monitoring software, such as application performance management software. For example, some embodiments may include a distributed application performance management application including the application monitor 18 and an application agent 32 (or plurality of application agents) executing on the computing devices 20 through 24. In some embodiments, the application agents may be configured to monitor performance of the application component 30. Monitoring performance may take a number of forms, and examples include measuring response times of various routines of the application component 30, for instance, durations of times elapsed between when a given routine is called and when the given routine returns a response. Other examples include gathering errors thrown by routines. In some embodiments, routines may be instrumented by adding calls to the application agent at the beginning and ends of the routines, such that the application agent receives a signal when a given routine in a given execution instance begins and ends, and the application agent may determine response times based on the signals by subtracting the time at which the begin signal was received from the time at which the end signal was received. In some embodiments, these routines may receive such signals from an operating system of a host. In some cases, the application agent and application component may be configured before both are installed on a computing device. For instance, code for the application component may be instrumented with calls to the application agent before that code is installed in a machine image or the computing device 20-24 that receives that machine image.

In some embodiments, the application agent 32 may gather attributes, metrics, and events of application components and report that gathered information to the application monitor 18, for instance, buffering the information and sending it periodically or sending the information responsive to queries. In some embodiments, the application monitor 18 may aggregate information gathered from a plurality of application agents executing on the computing devices 20 through 24 for a given distributed application and generate various dashboards, reports, and alarms. In some embodiments, the application monitor 18 may be configured to group reported metrics according to a given transaction serviced by the distributed application. For instance, a given website request and the chain of events in a pipeline by which the given website request is serviced is an example of a transaction. In many cases, the distributed application may service a relatively large number of transactions concurrently, for instance, after a relatively large number of users make requests at around the same time. Some embodiments may be configured to, for a given transaction, determine a total response time for the transaction, for instance, as perceived by a user, indicating a difference in time between when a request was received and when a response was provided for a user. Further, some embodiments may be configured to segment that response time for the transaction according to the contribution of each of the application components and routines therein. The various reports analyses, and dashboards described herein may be formed by instructing a computing device to render a graphical user interface depicting the same, for instance, by sending instructions to a web browser on a remote computing device or instructing a display of a computing device upon which the respective monitor 16 or 18 is executing. Thus, in some cases, a developer may be able to query the application monitor 18 for particularly slow transactions (or transactions for which an error occurred) and drill down into the particular application component and routine that contributed to the slow response or error.

Commercial examples of monitoring software that may be used in accordance with the present techniques include the following, any one of which may be modified to include the topology analyzer or may interface with the topology analyzer in some embodiments.

CA Unified Infrastructure Management (UIM)™ available from CA, Inc. of Islandia, N.Y. may be used to monitor and manage data center deployments and, in particular, those in a multi-tenancy use case, like in the enterprise cloud (e.g., Amazon Web Services™ or Azure™). Some implementations automatically discover computing devices, gather metrics (like CPU usage, memory usage, network activity, etc.) and alarms about the devices, and some implementations aggregate the data in various dashboards and reports. In some cases, this data is gathered and reported to a central server by an agent installed on monitored devices. An administrator console may be used to manually configure and deploy the monitoring agents, also called robots, which may be configured to have “probes,” or collections of code configured to monitor a particular type of software. Such probes may be characterized as agents in and of themselves more generally.

CA Application Performance Management (APM)™ available from CA, Inc. of Islandia, N.Y. may be used to monitor the performance of applications by providing fine-grained response times (and other metrics) attributable to portions of a call graph of the application (e.g., indicating which method, of the application called is servicing a request or is running particularly slow). In some cases, this is done by instrumenting the monitored code. An agent may execute on the computing device to receive signals from instrumented code or otherwise monitor the code through operating system interfaces. Embodiments may aggregate such data and present transaction traces that indicate the amounts of time consumed in servicing a user request attributable to various methods and services called when preparing the response to the request.

CA Application Delivery Analysis™ (ADA) available from CA, Inc. of Islandia, N.Y. may also be used to monitor the performance of software, e.g., providing relatively fine-grained measures response time viewed through the lens of network infrastructure. A developer or engineer may use CA ADA to determine that one of 50 servers in distributed system is responsible for a slowdown in a particular application feature for a subset of users. ADA may operate on layer-four of the Open Systems Interconnection (OSI) model, often the transport layer, such as on transport control protocol (TCP) metadata, like packet headers. By monitoring network exchanges, ADA may infer the as-built topology of a distributed application (e.g., what hosts are in a topology (and how they connect in the topology) and where there is redundancy in the topology). Often these topologies have one or more entry hosts (e.g., a web or API server) and a set of downstream hosts that perform back-end processes (e.g., controllers, databases, load balancers, servers that interface with third party API's, etc.).

Data from these monitoring applications 16 and 18 may be stored in the databases 15 and 17 and visualized with the data visualization application 11, in some cases with data access mediated by the database translator 12. In some embodiments, the data visualization application 11 and database translator 12 are part of the infrastructure monitor 16 or the application monitor 18, or in some cases they are stand-alone applications.

In some embodiments, the infrastructure monitor 16 may write infrastructure and monitoring data to the relational database 15. In some embodiments, the relational database 15 may include a plurality of tables, having columns and rows arranged in, for example, third normal form. In some embodiments, the columns may correspond to fields, the rows may correspond to entries in the database, and values at the intersection of columns and rows may reflect various metrics and events captured by the infrastructure monitor 16 and recorded in the database. In some cases, these events and metrics may be associated with a timestamp and a computing entity identifier, for example, a host identifier indicative of a host on the computing device in which the infrastructure agents described above are executing.

In some embodiments, the application monitor 18 may store application monitoring data in the noSQL (or other type of non-relational) database 17. In some embodiments, values may be stored in a serialized hierarchical data format, like JSON documents or XML documents. In some embodiments, the application monitoring data may be stored in a hierarchical arrangement of dictionaries and lists. In some embodiments, the data may be stored in keyvalue pairs.

In some embodiments, the data visualization application 11 is a Kibana™ server configured to prepare data visualizations responsive to API requests, such as a RESTful API request to display data in a non-relational database, such as non-relational database 17, in a dashboard described by a dashboard template in the dashboard template repository 13. In some cases, different developers and operations engineers associated with different monitored applications (e.g., different tenants) may define different templates. In some embodiments, these different templates may include a plurality of different panels in which different graphs or tables are arranged in a user interface. In some cases, these various graphs may include a plurality of visual elements arranged to provide a view into a database. Examples of such visual elements include icons representing events, metrics, computing devices, transactions, portions of transactions, and the like. In some cases, the visual elements are a segment of a pie chart, a bar in a bar graph, a point in a line graph, and icon representing a host or service in a network or service graph, or the like. In some cases, the visual element is text, for example, in a table listing alarms or in a description of a host or transaction revealed by selecting a corresponding icon.

In some cases, the data visualization application 11 may not be configured to interface with a relational database, such as database 15. For example, the data visualization application 11 may be configured to send queries in a query language corresponding to a non-relational database, and the data visualization application 11 may not be configured to send queries in a query language of a relational database, such as a version of a structured query language (SQL). Thus, the data visualization application 11 may not be configured to present data visualizations that combine or provide for navigation between data of the non-relational database 17 and data of the relational database 15. Similar problems may be presented by other applications configured to interface only with relational databases and not configured to interface with relational databases (or vice versa)

In some embodiments, the database translator 12 may serve as a translation layer between the data visualization application 11 and the databases 15 and 17, for example, making the databases 15 and 17 both appear to the data visualization application 11 as non-relational databases, for example, as a single non-relational database at a single network address and socket with a single query language. Or in some cases, the database translator 12 may be configured as a reverse proxy that routes requests pertaining to data in the no-SQL database to the data visualization application 11 and routes requests pertaining to data in the relational database 15 to another application, such as to the infrastructure monitor 16.

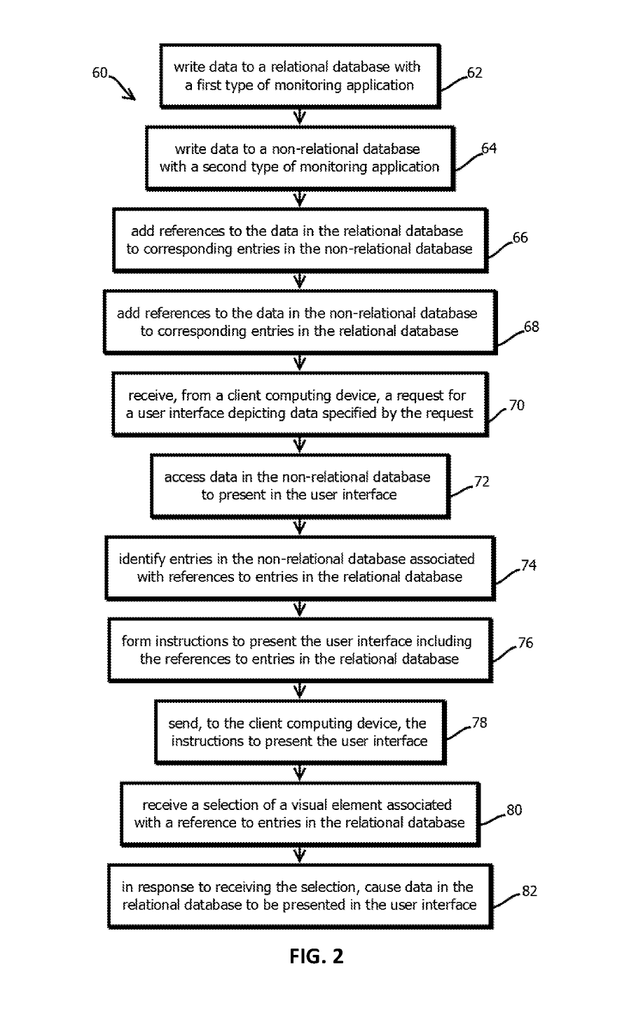

In some embodiments, the database translator 12 includes a controller 34, a request classifier 36, a query translator 38, a response translator 40, a cross-referencer 44, a proxy server 42, and a referential integrity manager 46. In some embodiments, the controller 34 may coordinate the operation of the other components 36 through 46 of the database translator 12 and execute a process described below with reference to FIG. 2.

In some embodiments, the database translator 12 includes a request classifier 36 operative to classify incoming requests to the data visualization application 11 or to classify requests from the data visualization application 11 to one of the databases 15 and 17 as pertaining to a particular type of database, such as a relational database or non-relational database. In some embodiments, the request classifier 36 may be configured to receive a query from the data visualization application 11 to what the data visualization application 11 perceives as a single non-relational database, and parse the query for tokens or other values in the query indicative of data residing in the non-relational database 15. In some cases, queries may include a token in a namespace corresponding to the non-relational database 15 or the relational database 17. The request classifier 36 may detect this token, for example, with a regular expression, and determine that the query pertains to one of the two databases 15 and 17. Upon determining that the query pertains to the no-SQL database 17, some embodiments may transmit the query without modification to the no-SQL database 17. Or some embodiments may modify a network and transport layer protocol header of packets conveying the request, for example, applying a TCP wrapper or modifying an extant header. Or some embodiments may pass the packets such that the packets are returned to the data visualization application 11 directly from the database 15.

In some embodiments, the query may be in a query language of the noSQL database 17. In some embodiments, the query may be a domain specific query language, such as that associated with the Elasticsearch™ database. In some embodiments, the query may include both scoring-criteria and filters. In some cases, scoring-criteria may correspond to scored attributes indicative of how closely documents or entries in documents satisfy portions of a query, and filters may correspond to a Boolean determination of whether a document is responsive to the corresponding portion of the query. For example, some embodiments may filter documents by an identifier of a computing device (e.g., a host thereon) or a window of time in which timestamps of modern data were gathered. In some cases, the query to the non-relational database may be expressed in a hierarchical data serialization format, and some cases in a hierarchical arrangement of lists and dictionaries.

In some embodiments, queries may be classified as pertaining to the relational database 15 by the classifier 36, and in response, some embodiments may cause those queries to be translated into a query language of the relational database by the query translator 38. In some cases, the query language of the relational database may take the form of a selected statement, or a particular field having a value that satisfies a query predicate, for instance, a where clause of a SQL query. In some embodiments, the query translator 38 may be configured to translate queries expressed in a query language of the non-relational database into queries expressed in a query language of the relational database. For example, some embodiments may parse a received query into an abstract syntax tree and traverse the abstract syntax tree, for instance, with a depth first or breadth first traversal to identify tokens that may be mapped to terms in a SQL query. Some embodiments may, for example, identify a term indicative of a table or set of tables. Some embodiments may detect the token indicative of a query predicate and, in response, identify tokens indicative of values to be returned by the query. Some embodiments may compose a SQL query from these detected tokens or from mappings between detected tokens and corresponding terms in the relational database and related query language. In some cases, template queries may be stored in memory with placeholders (e.g., arguments) for terms parsed from a query to the relational database with a mapping between those placeholders and terms in the non-relational database query. Some embodiments may then send the translator query to the relational database 15.

In some cases, responses from the relational database 15 may be in a format that is different from that expected by the data visualization application 11. Some embodiments may include a response translator 40 configured to format query responses from the relational database 15 to match those of a format of query responses returned by the noSQL database 17. For example, some embodiments may parse a comma separated value response to identify delimiters for lines and values and structure a hierarchical serialized version of the query response, e.g., arranging a table into nested lists and dictionaries. Or some embodiments may construct the query to the relational database such that the relational database 15 is instructed to return query results in the same format as the non-relational database 17.

In some embodiments, the database translator 12 may perform similar operations on behalf of an application configured to interface with the relational database 15, but not with the non-relational database 17. For example, some embodiments may receive a query in a query language of the relational database referencing data in the relational database 15 and determine to transmit that query unmodified to the relational database 15, for example, with the request classifier 36. In some cases, the request classifier 36 may be operative to also detect queries that reference data in the non-relational database 17 and convert those queries with the query translator 38. For example, some embodiments may segment a structured query language query according to reserved terms within the query, like a select, a from, a where, and a join statement. In some embodiments, a query in a different query language may be formed based on the detected structure and terms. For example, some embodiments may construct a JSONpath or X-path query based on the detected reserved terms, e.g., a table identifier may be separated by a query predicate by a path-delimiter, like a “/.”

In some embodiments, a cross-referencer module 44 may be configured to add cross-references to data in the relational database 15, the non-relational database 17, or both, for example, when data is written to one database or the other. In some embodiments, the cross-referencer 44 may insert these cross-references in response to a write operation to one of the databases, or in some embodiments, the cross-referencer 44 may execute periodically, for example, to construct an index that serves as a cross-reference. In some cases, the cross-referencer may take the form of a field in the relational database or a key-value pair in the non-relational database, for example, in a hierarchical grouping that includes data corresponding to the cross-reference.

In some embodiments, the cross-reference may be in the form of a token, like a tag, that serves as an identifier of data in the other database. In some embodiments, the tag may correspond to a query that maps to responsive data in the of the database. In some embodiments, the cross-reference may be the string corresponding to the query itself. In some embodiments, the cross-reference may take the form of a uniform resource identifier.

Data may be selected for cross-referencing with a variety of different techniques. In some cases, entries in the two databases may be linked by cross-references that correspond to computing device or hosts and durations of time. For example, entries in the two databases that describe performance of the computing device or application executing thereon at the same time may be designated with cross-references in the two databases. In some cases, the same cross-reference token may be in both databases. In some cases, other cross-references may be added, and some embodiments with multiple cross-references according to different ways of linking the data. For example, some embodiments may add cross-references corresponding to transactions, for example, instances in a given session with a given user in which the given user requests a particular functionality from a monitored application and received a result.

In some embodiments, the referential integrity manager 46 may be configured to maintain referential integrity in one database 15 or 17 as data in the other database 15 or 17 is modified. For example, before (or after or otherwise in response to) deleting data in one of the databases, some embodiments of the referential integrity manager 46 may determine whether there are any references to that data and the other database. In some cases, the referential integrity module 46 may determine whether those other references also pertain to undeleted data and should be preserved or whether the references pertain only to the data to be deleted and would represent a failed reference (e.g., a reference to data that is not present). In some embodiments, upon determining that a reference in the other database to the deleted data references only that deleted data, some embodiments may delete the reference from the other database as well. Alternatively, upon determining that the reference in the other database pertains to both deleted data and undeleted data, some embodiments may permit the reference to persist.

In some embodiments, the data visualization application 11 may have a RESTful API that does not maintain state about an ongoing session or maintains limited state. Accordingly, some embodiments of the data visualization application may be configured to combine references between the databases in graphical representations, such that user interactions cause those cross-references to be sent back to the data visualization application 11 or the database translator 12 to indicate that the data in the other database should be selected.

For example, some embodiments may send a set of instructions to present a dashboard or other user interface with data in one of the databases 15 or 17. In some cases, visual elements in the database may depict events and metrics in one of the databases 15 or 17, and those visual elements, in some cases, may be associated with references to data in the other database 15 or 17, for example, references to other data pertaining to the same computing device, the same host, around the same time (e.g., within plus or minus one second), or the same transaction. In some embodiments, an event handler of the graphical user interface may receive a user selection of one of the visual elements and send an indication that the user selected one of the visual elements along with the value of the cross-reference to the other database. In some cases, this cross-reference may be received by the database translator 12 or the data visualization application 11 and the database translator 12 may retrieve the cross-referenced data from the other database 15 or 17, or the data visualization application 11 may send a query including the cross-reference, which may cause the database translator 12 to translate the query and return the referenced data from the other database 15 or 17.

Thus, in some cases, a user may relatively quickly navigate back and forth between views into the two databases that are potentially causally related to one another. For example, a user may see a graphical visual element depicting an anomalous event in one of the database's data, such as an alarm or a metric indicating a particularly slow response time in a transaction. In some embodiments, the user may then select that visual element, and that visual element upon selection, may produce an event that causes an event handler to send a cross-reference back to the data visualization application 11 or the data translator 12, which may retrieve related data from the other database for presentation.

FIG. 2 shows an example of a process that may be implemented by some embodiments of the database translator 12 described above, but is not limited to that implementation, which is not to imply that any other feature described herein is limited to the described aspects. In some embodiments, multiple instances of the process 60 or subsets thereof may be executed concurrently, and some steps of the process 60 may be repeated or omitted, which again is not to imply that other descriptions are limiting. In some embodiments, the process 60 begins with performing the above-described monitoring operations to obtain monitoring data indicative of the performance of application and infrastructure upon which the application executes. In some embodiments, the process 60 includes writing data to a relational database with a first type of monitoring application, for example, one of the above types of monitoring applications, as indicated by block 62. In some embodiments, the process 60 also includes writing data to a non-relational database with a second type of application, as indicated by block 64. In some cases, the first type of application is an application performance monitoring application, and in some cases, the second type of monitoring application is an infrastructure monitoring application. Or different variations of monitoring applications or other types of data acquisition applications may write to these two databases.

Some embodiments may then add references to the data in the relational database to corresponding entries in the non-relational database, as indicated by block 66. In some cases, adding references may be done before the data is written or after the data is written. In some cases, references may be added periodically or in response to an event indicating that a write has occurred. In some cases, writing to one of the types of databases may cause references to be added to both of the databases. In some embodiments, corresponding entries may be determined with a variety of different techniques. Some embodiments may identify in the data to be written a timestamp, an identifier of a host (or other identifier of a computing device), an identifier of a transaction, or the like. Some embodiments may then query the other type of database for records pertaining to the same events, for example, records within a threshold duration of time of the timestamp, records pertaining to the same host, or records pertaining to the same transaction, or a combination thereof. Some embodiments may add a cross-reference, such as a unique string to the entries in one of the databases, that prompted these queries and to the entries in the other database that were responsive to these queries. In some cases, a cross-reference may be from a single value in one database to a plurality of values in the other, or vice versa.

Next, some embodiments may add references to data in the non-relational database to corresponding entries in the relational database, as indicated by block 68. In some cases, this may involve the same steps as were described above with reference to block 66, except in the other direction.

In some embodiments, blocks 66 and 68 may be performed by the above-described cross-referencer module 44.

In some embodiments, the cross-references may take the form of a unique cross-reference identifier with a prefix or suffix or other pattern that indicates a direction of the reference. For example, a reference to an entry in the non-relational database may have a prefix indicating the reference is to the non-relational database and a suffix that is a unique identifier. The corresponding entries in the non-relational database may include the same unique identifier. In some cases, the cross-references are not symmetric, for example, more entries in one database may reference other entries in the other database but not vice versa. In some cases, cross-references may be added in a third data structure, different from the two databases, such as an index. Additions to this third data structure are still additions of cross-references to the two databases.

Some embodiments may receive, from a client computing device, a request for a user interface depicting data specified by the request, as indicated by block 70. In some cases, this request may be from the above-described analysts computing device 14, for example, from a browser or special purpose application thereon sending an API request to the data visualization application 11. In some cases, the sent request may be in the form of a URL and may reference a particular account correspond to a particular dashboard in the dashboard template repository 13. For example, an operations engineer or developer may request a dashboard depicting application performance of a particular application, such as a dashboard corresponding to the application's performance.

In response, some embodiments may retrieve the corresponding template, identify references in the template to data by which the template is to be populated (for example, queries included in the template), and based on those queries, access data in the non-relational database to present in the user interface, as indicated by block 72. In some cases, this may include identifying entries in the non-relational database associated with references to entries in the relational database that were accessed, as indicated by block 74. For example, some embodiments may retrieve a record indicative of application performance and that record indicative of application performance may include a plurality of cross-references to data indicative of an infrastructure monitoring data on computing devices on which the transaction was serviced at the same or around the same time as the transaction. In some cases, some embodiments may embed those references in the user interface, such that user selections may cause communications that selectively identify those references back to the server to obtain the reference data.

Accordingly, some embodiments may form instructions to present the user interface including the references (e.g., cross-references) to entries in a relational database, as indicated by block 76. In some cases, forming the instructions includes forming webpage markup and browser-executable scripts that are sent to a remote analysts computing device for rendering in a browser. In some cases, the instructions include browser-executable scripts (e.g., JavaScript™ or web assembly) that provide for an event handler that detects user selections of visual elements in the user interface and processes indications of those user selections along with values referencing data in the relational database.

Some embodiments may send, to the client computing device, the instructions to present the user interface, as indicated by block 78. In some embodiments, the client computing device may render the instructions to present the user interface. Or in some cases, the user interface may be presented locally, on the same computing devices executing the process 60.

Next, some embodiments may receive a selection of a visual element associated with a reference to entries in the relational database, as indicated by block 80. In some cases, receiving a selection may include receiving a URL sent to the data visualization application, such as by one of the above-described event handlers to request content from the data visualization application 11 responsive to a user selection. In some cases, the request includes the identifier of some of the entries in the relational database. In response to receiving the selection, some embodiments may cause data in the relational database to be presented in the user interface, as indicated by block 82. In some cases, this may include the data visualization application 11 sending a query that includes the cross-reference, and the above-described database translator 12 translating that query from a query language of a non-relational database into a query language of a relational database. Or in some cases, this may include intercepting the request to the data visualization application and servicing the request independently of the data visualization application and sending the data in the relational database back to the client device. Or in some cases, the data responsive to the selection may be sent along with the user interface and held in cache memory of the client computing device for use upon a user selection. Thus, in some cases, upon a user requesting a user interface, some embodiments may retrieve all related data associated with the depicted visual elements and store the data in cache memory of the client computing device for relatively low latency response to a user selection.

An example of a user interface consistent with the present techniques may include a dashboard. In some embodiments, the dashboard may include a plurality of visual elements in a plurality of graphs, and those visual elements be the user selectable. Upon a user selecting a given one of the visual elements, the dashboard view may transition to a new state. In some embodiments, the information shown the post-selection state includes data from a different database than that of the data corresponding to the visual element that was selected. In some embodiments, this interaction may be generated by interfacing with a data visualization application that is not configured to interface with these different types of databases, in some cases while maintaining a RESTful API of the data visualization application and without accessing source code of the data visualization application.

FIG. 3 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a datacenter, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a datacenter or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the techniques. It is to be understood that the forms of the techniques shown and described herein are to be taken as examples of embodiments. Elements and materials may be substituted for those illustrated and described herein, parts and processes may be reversed or omitted, and certain features of the techniques may be utilized independently, all as would be apparent to one skilled in the art after having the benefit of this description of the techniques. Changes may be made in the elements described herein without departing from the spirit and scope of the techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:

1. A method of forming user interfaces based on data that spans relational and non-relational databases, the method comprising: receiving, with one or more processors, a request for a user interface depicting data specified, at least in part, by the request; in response to receiving the request, accessing, with one or more processors, data in a first type of database, the data in the first type of database including references to entries in a second type of database different from the first type of database, wherein the two types of databases include a relational database and a non-relational database; forming, with one or more processors, instructions to present a user interface depicting accessed data in the first type of database specified, at least in part, by the request, wherein: the user interface includes a user-selectable visual element associated with an event handler and a first reference from the first type of database to one or more entries in the second type of database, the user-selectable visual element depicts at least some of the accessed data in the first type of database that is associated in the first type of database with the first reference to one or more entries in the second type of database, and user selection of the visual element causes the event handler to send an indication that the visual element was selected and the first reference from the first type of database to one or more entries in the second type of database; receiving, with one or more processors, the indication that the visual element was selected and the first reference from the first type of database to one or more entries in the second type of database; and in response to receiving the indication, accessing, with one or more processors, the one or more entries in the second type of database based on the first reference and causing the accessed one or more entries in the second type of database to be presented in the user interface.
2. The method of embodiment 1, wherein: the first type of database is a non-relational database; the second type of database is a relational database; the method comprises: storing first monitoring data from a first monitoring application in the non-relational database, the first monitoring data being indicative of performance of a distributed application executing on a plurality of computing devices; storing second monitoring data from a second monitoring application different from the first monitoring application in the relational database, the second monitoring data being indicative of performance of the distributed application executing on the plurality of computing devices, the first monitoring data including different metrics or events from metrics or event in the second monitoring data, at least some of the first monitoring data indicating a cause of a metric or event in the second monitoring data or vice versa; and forming instructions to present the user interface comprises forming instructions to present a monitoring-data dashboard with a plurality of graphs, wherein a plurality of visual elements of the monitoring-data dashboard are user selectable to navigate from a selected visual element depicting data in the non-relational database to another visual element depicting data in the relational database, or vice versa.
3. The method of any one of embodiments 1-2, wherein: the user interface comprises a data visualization formed by a data visualization application that is not configured to form visualizations of data in a relational database; and the user-selectable visual element is added to the data visualization by the data visualization application.
4. The method of embodiment 3, comprising: receiving a data access request sent by the data visualization application; determining that the data access request includes the first reference; in response to the determination: translating the data access request from a first query language to a second query language different from the first query language; and selecting a database among the first type of database and the second type of databases corresponding to the second query language.
5. The method of embodiment 4, wherein translating the data access request comprises: parsing a data access request formatted as a hierarchical arrangement of dictionaries and lists to form an abstract syntax tree; traversing the abstract syntax tree to identify a table identifier and value of a field in a table corresponding to the table identifier; and forming a structured query language query selecting entries having the value of the field from the identified table and requesting the return of responsive data in the form of a hierarchical arrangement of dictionaries and lists.
6. The method of embodiment 3, comprising: receiving a data access request sent by the data visualization application; determining that the data access request does not include a reference to data in a relational database among the first type of databases and the second type database; and in response to the determination, sending the data access request without translating the other data access request into another query language.
7. The method of any one of embodiments 1-6, wherein: the first reference is a query in a query language of the second type of database.
8. The method of embodiment 7, wherein: the query language of the first type of database is not a version of a structured query language; and the query language of the second type of database is a version of a structured query language.
9. The method of any one of embodiments 1-8, comprising: entries in the second type of database include references to entries in the first type of database; and the references to entries in the first type of database correspond to filters configured to filter entries in a non-relational document database.
10. The method of any one of embodiments 1-9, comprising: receiving a request to delete a given record stored in the second type of database; in response to the request to delete the given record, accessing the first type of database to identify references to the given record; causing the first type of database to delete the accessed references to the given record; and causing the second type of database to delete the given record.
11. The method of embodiment 10, comprising: before causing the first type of database to delete the accessed references to the given record, determining that the deleted references to the given record do not reference other records in the second type of database.
12. The method of any one of embodiments 1-11, comprising: receiving monitoring data from a plurality of infrastructure monitoring agents executing on a plurality of computing devices executing a distributed application; writing the infrastructure monitoring data to the second type of database; and adding references to the infrastructure monitoring data to records in the first type of database describing performance of the distributed application, wherein adding references to the infrastructure monitoring data to records in the first type of database comprises: obtaining host identifiers or computing device identifiers of hosts or computing devices monitored by the respective infrastructure monitoring agents; selecting different subsets of the data in the first type of database based on the different subsets corresponding to different ones of the host identifiers or computing device identifiers; and adding different references to the different subsets corresponding to different monitoring data of the different hosts or computing devices.
13. The method of embodiment 12, wherein: the records in the first type of database describe performance of the distributed application and include a plurality of transaction records each indicating performance of the distributed application in a corresponding session with a user computing device, wherein selecting different subsets comprises selecting different subsets based on correspondence between timestamps of the records in the first type of database and timestamps of the data in the second type of database referenced by the added references.
14. The method of any one of embodiments 1-13, wherein: the request for the user interface is received by a proxy server the method comprises: determining, with the proxy server, that the request pertains to data in the first type of database and, in response, sending the request to a data visualization application configured to interface with the first type of database but not the second type of database to obtain data depicted in visualizations; receiving another request for content for the user interface; determining that the other request for content pertains to data in the second type of database based on the other request for content including the first reference and, in response, sending the other request for content to a monitoring application configured to write to and read from the second type of database and not sending the other request for content to the data visualization application.
15. The method of any one of embodiments 1-14, comprising: writing data to the second type of database gathered with steps for monitoring infrastructure; and writing data to the first type of database gathered with steps for monitoring application performance.
16. A tangible, non-transitory, machine-readable medium storing instructions that when executed by a data processing apparatus cause the data processing apparatus to perform operations comprising: the operations of any of embodiments 1-15.
16. A system, comprising: one or more processors; and memory storing instructions that when executed by the processors cause the processors to effectuate operations comprising: the operations of any of embodiments 1-15.

What is claimed is:

1. A method of forming user interfaces based on data that spans relational and non-relational databases, the method comprising:
receiving, with one or more processors, a request for a user interface depicting data specified, at least in part, by the request;
in response to receiving the request, accessing, with one or more processors, data in a first type of database, the data in the first type of database including references to entries in a second type of database different from the first type of database, wherein the two types of databases include a relational database and a non-relational database;
forming, with one or more processors, instructions to present a user interface depicting accessed data in the first type of database specified, at least in part, by the request, wherein:
the user interface includes a user-selectable visual element associated with an event handler and a first reference from the first type of database to one or more entries in the second type of database,
the user-selectable visual element depicts at least some of the accessed data in the first type of database that is associated in the first type of database with the first reference to one or more entries in the second type of database, and
user selection of the visual element causes the event handler to send an indication that the visual element was selected and the first reference from the first type of database to one or more entries in the second type of database;
receiving, with one or more processors, the indication that the visual element was selected and the first reference from the first type of database to one or more entries in the second type of database; and
in response to receiving the indication, accessing, with one or more processors, the one or more entries in the second type of database based on the first reference and causing the accessed one or more entries in the second type of database to be presented in the user interface.

2. The method of claim 1, wherein:
the first type of database is a non-relational database;
the second type of database is a relational database;
the method comprises:
storing first monitoring data from a first monitoring application in the non-relational database, the first monitoring data being indicative of performance of a distributed application executing on a plurality of computing devices;
storing second monitoring data from a second monitoring application different from the first monitoring application in the relational database, the second monitoring data being indicative of performance of the distributed application executing on the plurality of computing devices, the first monitoring data including different metrics or events from metrics or event in the second monitoring data, at least some of the first monitoring data indicating a cause of a metric or event in the second monitoring data or vice versa; and
forming instructions to present the user interface comprises forming instructions to present a monitoring-data dashboard with a plurality of graphs, wherein a plurality of visual elements of the monitoring-data dashboard are user selectable to navigate from a selected visual element depicting data in the non-relational database to another visual element depicting data in the relational database, or vice versa.

3. The method of claim 1, wherein:
the user interface comprises a data visualization formed by a data visualization application that is not configured to form visualizations of data in a relational database; and
the user-selectable visual element is added to the data visualization by the data visualization application.

4. The method of claim 3, comprising:
receiving a data access request sent by the data visualization application;
determining that the data access request includes the first reference;
in response to the determination:
translating the data access request from a first query language to a second query language different from the first query language; and
selecting a database among the first type of database and the second type of databases corresponding to the second query language.

5. The method of claim 4, wherein translating the data access request comprises:
parsing a data access request formatted as a hierarchical arrangement of dictionaries and lists to form an abstract syntax tree;
traversing the abstract syntax tree to identify a table identifier and value of a field in a table corresponding to the table identifier; and
forming a structured query language query selecting entries having the value of the field from the identified table and requesting the return of responsive data in the form of a hierarchical arrangement of dictionaries and lists.

6. The method of claim 3, comprising:
receiving a data access request sent by the data visualization application;
determining that the data access request does not include a reference to data in a relational database among the first type of databases and the second type database; and
in response to the determination, sending the data access request without translating the other data access request into another query language.

7. The method of claim 1, wherein:
the first reference is a query in a query language of the second type of database.

8. The method of claim 7, wherein:
the query language of the first type of database is not a version of a structured query language; and
the query language of the second type of database is a version of a structured query language.

9. The method of claim 1, comprising:
entries in the second type of database include references to entries in the first type of database; and
the references to entries in the first type of database correspond to filters configured to filter entries in a non-relational document database.

10. The method of claim 1, comprising:
receiving a request to delete a given record stored in the second type of database;
in response to the request to delete the given record, accessing the first type of database to identify references to the given record;
causing the first type of database to delete the accessed references to the given record; and
causing the second type of database to delete the given record.

11. The method of claim 10, comprising:
before causing the first type of database to delete the accessed references to the given record, determining that the deleted references to the given record do not reference other records in the second type of database.

12. The method of claim 1, comprising:
receiving monitoring data from a plurality of infrastructure monitoring agents executing on a plurality of computing devices executing a distributed application;
writing the infrastructure monitoring data to the second type of database; and
adding references to the infrastructure monitoring data to records in the first type of database describing performance of the distributed application, wherein adding references to the infrastructure monitoring data to records in the first type of database comprises:
obtaining host identifiers or computing device identifiers of hosts or computing devices monitored by the respective infrastructure monitoring agents;
selecting different subsets of the data in the first type of database based on the different subsets corresponding to different ones of the host identifiers or computing device identifiers; and
adding different references to the different subsets corresponding to different monitoring data of the different hosts or computing devices.

13. The method of claim 12, wherein:
the records in the first type of database describe performance of the distributed application and include a plurality of transaction records each indicating performance of the distributed application in a corresponding session with a user computing device, wherein selecting different subsets comprises selecting different subsets based on correspondence between timestamps of the records in the first type of database and timestamps of the data in the second type of database referenced by the added references.

14. The method of claim 1, wherein:
the request for the user interface is received by a proxy server;
the method comprises:
determining, with the proxy server, that the request pertains to data in the first type of database and, in response, sending the request to a data visualization application configured to interface with the first type of database but not the second type of database to obtain data depicted in visualizations;
receiving another request for content for the user interface;
determining that the other request for content pertains to data in the second type of database based on the other request for content including the first reference and, in response, sending the other request for content to a monitoring application configured to write to and read from the second type of database and not sending the other request for content to the data visualization application.

15. The method of claim 1, comprising:
steps for cross referencing between a relational database and a non-relational database.

16. The method of claim 1, comprising:
writing data to the second type of database gathered with steps for monitoring infrastructure; and
writing data to the first type of database gathered with steps for monitoring application performance.

17. A tangible, non-transitory, machine-readable medium storing instructions that when executed by one or more processors effectuate operations comprising:
receiving a request for a user interface depicting data specified, at least in part, by the request;
in response to receiving the request, accessing data in a first type of database, the data in the first type of database including references to entries in a second type of database different from the first type of database, wherein the two types of databases include a relational database and a non-relational database;
forming instructions to present a user interface depicting accessed data in the first type of database specified, at least in part, by the request, wherein:
the user interface includes a user-selectable visual element associated with an event handler and a first reference from the first type of database to one or more entries in the second type of database,
the user-selectable visual element depicts at least some of the accessed data in the first type of database that is associated in the first type of database with the first reference to one or more entries in the second type of database, and
user selection of the visual element causes the event handler to send an indication that the visual element was selected and the first reference from the first type of database to one or more entries in the second type of database;
receiving the indication that the visual element was selected and the first reference from the first type of database to one or more entries in the second type of database; and
in response to receiving the indication, accessing the one or more entries in the second type of database based on the first reference and causing the accessed one or more entries in the second type of database to be presented in the user interface.

18. The medium of claim 17, wherein:
the user interface comprises a data visualization formed by a data visualization application that is not configured to form visualizations of data in a relational database; and
the user-selectable visual element is added to the data visualization by the data visualization application.

19. The medium of claim 18, comprising:
receiving a data access request sent by the data visualization application;
determining that the data access request includes the first reference;
in response to the determination:
translating the data access request from a first query language to a second query language different from the first query language; and
selecting a database among the first type of database and the second type of databases corresponding to the second query language.

20. The medium of claim 17, wherein:
the request for the user interface is received by a proxy server;
the method comprises:
determining, with the proxy server, that the request pertains to data in the first type of database and, in response, sending the request to a data visualization application configured to interface with the first type of database but not the second type of database to obtain data depicted in visualizations;
receiving another request for content for the user interface;
determining that the other request for content pertains to data in the second type of database based on the other request for content including the first reference and, in response, sending the other request for content to a monitoring application configured to write to and read from the second type of database and not sending the other request for content to the data visualization application.
